(19) United States
(12) Patent Application Publication
(10) Pub. No.: US 2011/0128742 A9
(43) Pub. Date: Jun. 2, 2011

(54) High efficiency low cost safety light emitting diode illumination device

(76) Inventors: Pui Hang Yuen, Shatin (HK); Sik Hing Yuen, Foster City, CA (US)

(21) Appl. No.: 12/006,844

(22) Filed: Jan. 6, 2008

Related U.S. Application Data
(60) Provisional application No. 60/879,254, filed on Jan. 7, 2007.

(51) Int. Cl. F21V 29/02; H01K 1/14

(52) U.S. Cl. 362/294; 362/373; 313/315

(57) ABSTRACT

An illumination device of high intensity light emitting diodes, produces broad illumination with high efficiency, electromagnetic compatibility, and human safety, at low manufacturing cost. Special structures of the device simultaneously provide highly efficient heat sinking, human safety protection, electromagnetic shielding, optical optimization, and 3-dimensional compatibility with traditional incandescent lamp fixtures and applications. Structures, shape, and layers of materials of the device enable industry standard safety requirements to be met.

### OBJECTS OF THE INVENTION

It is an object of the invention to provide an LED illumination device which has the ability to illuminate a broad radial and near-axial pattern. It is another object of the invention to provide an LED illumination device which has the ability to illuminate to the rear of the device toward the base.

It is another object of the invention to provide an LED illumination device in which the LED die temperature is maintained at lower level.

It is another object of the invention to provide an LED illumination device which guards the user from touching hot metallic parts of the device. It is another object of the invention to provide an LED illumination device which guards the user electric shock.

It is another object of the invention to provide an LED illumination device in which the device is guarded from damage due to electrostatic discharge.

It is another object of the invention to provide an LED illumination device which has the ability to generate illumination comparable to or in excess of conventional incandescent and fluorescent light bulbs of 40 Watts of power or above.

It is another object of the invention to provide an LED illumination device which has the ability to fit into existing fixtures designed for normal incandescent light bulbs.

It is another object of the invention to provide a structure for highly efficient thermal dissipation as part of an LED illumination system.

It is another object of the invention to provide an LED illumination device made of low cost materials. It is another object of the invention to provide an LED illumination device with low cost of manufacturing.

It is another object of the invention to provide an LED illumination device that may withstand vibration and mechanical shock.

It is another object of the invention to provide an LED illumination device which has diffuse illumination or defocused illumination.

It is another object of the invention to provide an LED illumination device which is pleasing shape and visible appearance.

It is another object of the invention to provide an LED illumination device to have high longevity.

It is another object of the invention to provide an LED illumination device conforming to existing safety standards for incandescent and fluorescent light bulbs.

It is another object of the invention to provide an LED illumination device conforming to existing size industry standards for incandescent and fluorescent light bulbs. It is another object of the invention to provide an LED illumination device conforming to existing user standards for incandescent and fluorescent light bulbs. It is another object of the invention to provide an LED illumination device that may fit and function in fixtures normally used for incandescent and fluorescent light bulbs.

It is another object of the invention to provide an LED illumination device which may pass the testing standards of safety standard organizations for LED, incandescent, and fluorescent light bulbs.

### DESCRIPTION OF THE INVENTION

The described invention LED illumination device consists of power source contacts, LED driving circuitry, singular or a plurality of LED light sources, shaped singular or a plurality of multiple mounting surfaces, heat dissipation structures, mechanical and electrical bonding structures, structures that are transmissive or unobstructive to light, thermally conductive and thermally insulative structures and materials, and electrically conductive and insulative structures. The power source contact provides operative interconnectivity with electrical power from a power source or plurality of power sources, LED driving circuitry provides power supply suitable for the LED light sources, with alternating and or direct current converted from the power source connection and driving circuitry; the LED light sources provide illumination comparable to, or exceeding the performance of, conventional incandescent, gas discharge, or fluorescent light bulbs; the shapes, placement, structure, arrangement, and angular displacement of the LED die mounting surfaces provide a variety of specific illumination patterns matching the die luminosity characteristics and directionality of the desired light illumination; heat dissipation structures transfer heat generated by the LED die light source(s), and provide efficient means for heat dissipation to the ambient environment; electrically insulative structures provides electrical shock protection to the user and the installer.

A preferred embodiment of the invention, provides a faceted flat structure and or multi-faceted flat structures upon which to mount high power LED dies or LED modules. This provides a very advantageous mounting for such LED dies and modular light sources are as they are normally flat-bottomed dies or modules, designed to be mounted on a flat surface, with the maximum surface area of the die, thus contacting the faceted flat structure, providing better thermal conductivity with the faceted structures, working to efficiently conduct thermal energy to the invention's heat sink structures with a flat surface, cooling the temperature of the LED die or modular LED light source(s). Flat surfaces are utilized for mounting LED light source in the described invention.

In another embodiment of the invention, a plurality of singular die or modular LED light sources each having narrow illumination dispersion angles of field luminosity are arranged in an array in different angles of direction upon a multifaceted structure such that a specific pattern and or a wider dispersion angle of field luminosity is provided by the use of overlapping luminosity fields.

In yet another embodiment of the invention, electric insulation material of good heat conductivity are incorporated in the structure providing paths for heat dissipation, while avoiding electric shock and electrostatic discharge problems, and electromagnetic interference conduction.

In this embodiment, both user and the described invention device are protected from vulnerability to harmful contact between the user and the circuitry are avoided. This provides non-metallic bonding and interface materials that are thermally conductive at the die mounting, and other non-metallic materials that are part of the outer surfaces and interface surfaces that are non-thermally conductive, while presenting a cooler surface that may be in contact with the user or installer. In this embodiment, a laminate or multiple layer structure is utilized.

In an embodiment of the described invention LED illumination device, there are singular and/or a plurality of flat surfaces arranged in different directions, being the mounting surfaces for LED light sources. The said mounting surfaces are utilized to provide advantageous angles of direction for the LED light sources to broadly illuminate, to provide overlapping fields of illumination for each of the LED light sources, thereby making no gaps in the illumination field, thus providing illumination of broad radial and near-axial pattern, and the ability to illuminate to the rear of the device toward the base. The said mounting surfaces are utilized to also provide good thermal conductivity to the heat dissipation structure, to provide improved ability to maintain LED temperature at lower level.

In an embodiment of the described invention LED illumination device, at least 3 LED light sources, including LED units, and/or LED dies, and/or LED modules, are being mounted on multiple mounting surfaces facing different directions. The utilization of multiple said LED light sources provides the ability to generate high intensity of illumination, comparable to the illumination of conventional light bulbs of, including but not limited to 40 Watts of incandescent light or more. The utilization of multiple said LED light sources also provides broad angle dispersed and homogeneous illumination by mounting on said mounting surfaces of the described invention. In shown in FIG. 101,

A structure with thick metal and/or other efficient heat conducting material, being the heat dissipation structure, is utilized in an embodiment of the described invention LED illumination device. In addition, the said heat dissipation structure also has large number of surfaces due to the specific shape of the structures and the surface area for convective interface thermal exchange with the ambient environment. The thick structure of the said heat dissipation structure is to provide good and ample thermal mass and improved conductivity from the mounting surfaces to the heat dissipation surfaces of the heatsinking and convective interface for thermal exchange with the ambient environment. The large amount of surface of the heat dissipation surface is to provide an efficient escape for the heat, in combination to the thick structure, providing improved ability to maintain LED temperature at lower level.

In a preferred embodiment of the described invention, the construction of the heat dissipation heat sinking thermal interface and thermal exchange structure is structured in such a way that, a substantial part of the illumination from the LED light sources toward the rear of the said device is not being blocked or obscured by the heatsinking structure, to provide improved illumination toward the area around the rear of the said device and toward the area surrounding the base; this is advantageous for various applications that may be found in the user mounting and deployment environment.

A special insulative structure made of electrically insulative material is utilized in an embodiment of the described invention LED illumination device, to provide insulation between the user and/or any electrical conductive part of the said device accessible to the user from the circuitry, in which part or all of the said insulation structure is made of efficient heat conducting material, and becomes part or all of the heat dissipation structure of the said device. The said insulation structure is utilized to provide protection to the user from electric shock. The said insulation structure is utilized to also provide protection to the invention LED illumination device from damage due to electromagnetic discharge. The efficient heat conducting material utilized in the insulation structure is specifically and specially chosen and utilized to include and provide electrical insulation while maintaining heat exchange and dissipation efficiency.

Optionally, or in addition to the heat dissipation structure of the described invention LED illumination device, a protection layer is utilized on surfaces which are accessible to the user of the said heat dissipation structure, to provide further protection to the user from electric shock. The said protection layer is utilized to also provide protection to the user from the touch of possibly hot metallic part of the said heat dissipation structure. The said protection layer is utilized to also provide improved protection to the invention LED illumination device from damage due to electromagnetic discharge.

In an embodiment of the invention, the structures are shaped to enable the various parts of the invention to function, especially providing heat and electrical insulation, and heat exchange conductive and/or convective cooling of the structure, while preventing harmful contact to a human finger or a test probe shaped similar to a human finger, as is utilized in testing by standards organizations and industry safety testing laboratories. One example of this probe simulating the human finger is the safety test probe used by Underwriter's Laboratories. In an embodiment of the invention, the structures of the invention are shaped so as to block entry by the said test probe, and preventing contact by it to electrically conductive material or metal. Laminated materials or layers of material, or coatings are used in an embodiment of the invention at specific points on the structure to prevent contact by the said test probe. Laminated materials or layers of material, or coatings are used in an embodiment of the invention at specific points on the structure to prevent contact by the said test probe.

As a part of or in addition to the other embodiments described invention LED illumination device, one or more outer membranes which allow light to pass through is/are utilized to cover any or all of the LED light sources and part of the heat dissipation structure of the invention LED illumination device. The said outer membrane is/are utilized to provide protection to the user from electric shock by touching any part of circuitry. The said outer membrane is/are utilized to also provide different patterns of illumination, including but not limited to diffused illumination similar to conventional light bulb. The said outer membrane also provides an aesthetically pleasing appearance to the buyer or user of the invention. The said outer membrane also provides a shape conforming to existing standards for incandescent and fluorescent light bulbs, and a shape compatible with existing lighting fixtures for mounting the invention.

Alternatively, or in addition to the described invention LED illumination device, the heat dissipation structure has a hollow space containing part of the circuitry, to provide the ability to design the shape of the said device in more compact shapes while having high efficiency in heat dissipation, including but not limited to dimensions similar to normal incandescent light bulbs, providing the ability to fit into existing fixtures designed for normal incandescent light bulbs. The cavity of the heat sink structure provides protection for the circuitry and electromagnetic shielding. It optionally provides heat sinking for the electrical circuit electronic parts.

This specification includes preferred embodiment of the invention and some of the variations in specific implementation through embodiments of the invention, but the invention is not limited to these described specific implementations. These serve to illustrate some of the possible embodiments of the invention. Numbering of various elements in the figures refer to similar or same elements in the figures having corresponding element numbers.

As shown in FIG. 1, the circuit for a preferred embodiment utilizes a series driven LED electrical connection circuit for lower current implementation. Alternatively, the a parallel driven circuit as shown in FIG. 2 or a combination of parallel and series as shown in FIG. 3 may be utilized in alternative embodiments of the invention.

FIG. 4 shows a sectionally sliced view of a preferred embodiment of the invention LED illumination device described herein. Multiple LED units 101, being the LED light sources, are mounted on multiple flat surfaces as mounting surfaces, each of which is a surface of a piece of metal or conductive material 102 such as copper plate. The LED unit is mated on the flat surface with the cathode and the heat dissipation element of it being bonded by bonding compound such as solder to the metal or conductive material copper plate as shown in FIG. 5, to provide better contact for improved thermal conductivity. The anode of the LED unit is insulated from the metal plate by insulation material layer 109 and connected to other parts of the circuit by electrical conductor 110 such as wire, while the cathode is connected by electrical conductor 111 such as wire to other parts of the circuit.

As shown in FIGS. 4 and 6, metal or conductive material 102 such as copper plate, as a part of the heat dissipation structure, are mated with an heat conductive material 103 such as aluminum structure, which is another part of the heat dissipation structure, with a layer of heat conductive material 104 and or bonding compound such as silicone 104 in between, being a part of the electrically insulative structure as well as heat dissipative structure, and the an heat conductive material 103 are fixed in place by a structure fixing part 105, as a part of the insulation structure. The heat generated by the LED units is received by the metal or conductive material 102, conducted through the heat conductive material 104, to the heat sink underneath and dissipated, while the heat sink is insulated from the circuitry by the layer of heat conductive material having electrical insulative properties with high electrical breakdown voltage, typically 4 kV which is also the industry standard for testing standards organization certification such as of CE certification. Alternatively, the heat conductive insulation layer is at a different position as shown in FIG. 7, such that all LED units are soldered on a piece of metal 106, a heat conductive layer of material such as silicone or mica is utilized as the heat conductive electrically insulative element, and the circuit in FIG. 2 or 3 is utilized in this case.

In preferred embodiment of the invention described herein, as shown in FIG. 4, an LED electronic driving circuit 115 alternately with AC or DC conversion capability is mounted in a plastic housing 116, as a part of the insulation structure, inside a specially shaped cavity within the heat sink 103, and is connected to the LED units by insulated conductors 117 such as double insulation wires and to a conventional Edison type screw base 118 for AC power source, providing power conversion from AC power to DC power for driving the LED units and the entire circuit is insulated from the user.

In another embodiment of the invention, referring to FIG. 8, highly heat conductive ceramic material is utilized as the material for the heat sink structure 107 instead of or in addition to aluminum parts, and the heat sink becomes the a part of the insulation structure as well as heat dissipation structure. Metal soldering pads 108 are bonded on flat surfaces, the electrodes and the heat dissipation element of the LED units are soldered on these pads for mounting and heat contact, and a heat conductive compound such as heat conductive silicone is applied around the soldering for better heat conduction. The alternative embodiment described herein realizes the an objective of the invention of having a simple insulation structure.

In a preferred embodiment of the invention described herein, referring to FIG. 4, a heat sink 103 has a sufficient thickness in the part shown in FIG. 6, to maintains a thick structure near the heat sink fins 113, providing better thermal mass and heat conduction to the heat sink fins heat radiating structure. The specific shape of this structure importantly provides several functions simultaneously. The heat sink in this embodiment, as shown in FIGS. 11 and 12, has radially arranged fins 113 in a shape that fits within the shank of the 3D footprint of an industry standard normal incandescent bulb, and sawtooth segments 121 are utilized to enable illumination in directions toward the base by not obscuring the photons emitted by the illuminator active parts of the LED dies and modules. On the surfaces of the heat sink in this embodiment which are accessible to the user, a layer of coating 119 is utilized to provide protection to the user from the touch of hot metal and insulation from the circuit. Alternatively, or in addition to the heat sink structure, a hollow space or cavity is constructed within the heat sink fins as shown in FIG. 13, and there are holes 114 for air to pass through, providing better ventilation and more surfaces area for heat dissipation.

Referring to FIG. 4, a diffused sanded glass bulb or a clear glass semi-globular structure 120 is utilized as the outer membrane in a preferred embodiment, which covers the LED units and circuits and part of the heat sink, and simultaneously allows illumination from the LED light source to pass through and diffuse, to provide protection to the user from electric shock and the touch of hot metal, protection to the device from damage of electromagnetic discharge, and illumination that resembles conventional incandescent light bulbs.

In a preferred embodiment of the invention described herein, the mounting surfaces for the LED units are arranged to face in different directions as shown in FIGS. 9 and 10, showing a top view and side view of the copper plates 102 and the shape of the corresponding part of the heat sink 103. The directions of the LED units 101, each of which has an illumination angle of 120 degrees, are manipulated to provide overlapping fields of illumination 112, thereby making no gaps in the illumination field and illuminates to the rear of the device, providing vertical illumination range up to approximately 240 degrees as shown in FIG. 10, and illumination toward the rear is not being block or obscured by the heat sink as shown in FIG. 4.

### DESCRIPTION OF DRAWINGS AND FIGURES OF THE INVENTION

FIG. 1 shows a block diagram of a serial driven circuit for an LED illumination device

FIG. 2 shows a block diagram of a parallel driven circuit for an LED illumination device

FIG. 3 shows a block diagram of a serial and parallel driven circuit for an LED illumination device

FIG. 4 shows an cross-sectional view of a preferred embodiment of the invention.

FIG. 5 shows a view of an area of mounting and layers of materials of the structure and contact between the LED die unit and the mounting structure base in a preferred embodiment

FIG. 6 shows a view of an area of mounting and layers of materials of the structure and contact and between the LED die unit and the mounting structure base and a covering protective membrane structure having holes in a preferred embodiment

FIG. 7 shows a cross-sectional view of a mounting area of the structure for the LED units, layers of materials, specific shape of heatsinking structure, cavity for electronic circuit and connections, in an embodiment of the invention

FIG. 8 shows a view of the mounting of LED die unit with connectivity and conductivity layers with multi-faceted structure for mounting LED die units, with one LED shown mounted, and or metallic and or composite and or ceramic heat sink structure for an embodiment of the invention.

FIG. 9 shows a top view of the conductive layer material such as copper plate arrangement and corresponding part of a faceted heat sink in an embodiment of the invention

FIG. 10 shows a side view of the conductive layer material such as copper plate arrangement and corresponding part of a faceted heat sink in an embodiment of the invention

FIG. 11 shows a cross-sectional view

FIG. 12 shows a cross-sectional view of illumination

FIG. 13 shows a cross-sectional view of layers and shaped fins of material in the shank of the structure of an embodiment of the invention

FIG. 14 shows a cross-sectional view of electronic circuit and layers and shaped fins of material in the upper shank body of the structure of an embodiment of the invention

FIG. 15 shows a cross-sectional view of electronic circuit and layers and shaped fins of material in the upper shank body of the structure of an embodiment of the invention

FIG. 16 shows a cross-sectional view of the overall body for the invention structure with the cross section slice at the junction of the materials of membrane cover, heat sink, mounting area, and layers and shaped fins of material in the shank body of the structure of an embodiment of the invention

FIG. 17 Shows a side view of external areas of an embodiment of the invention

FIG. 18 Shows a bottom view of external areas of an embodiment of the invention

FIG. 19 shows a cross-sectional view of layers and shaped fins of material in the interior area of the upper LED mounting structure of an embodiment of the invention

FIG. 20 shows a view of shaped fins of material in the exterior area of the heatsinking structure and the upper LED mounting structure of an embodiment of the invention

FIG. 21 shows a bottom view of layers and shaped fins of material in the interior area of the upper LED mounting structure of an embodiment of the invention

FIG. 22 shows a cross-sectional view of layers and shaped fins of material in the interior area and heatsinking area of the structure of an embodiment of the invention

FIG. 23 shows a perspective view of layers and shaped fins of material in the interior area of the upper LED mounting structure of an embodiment of the invention

FIG. 24 Shows a side perspective view of external areas with details of various alternative embodiments of the invention

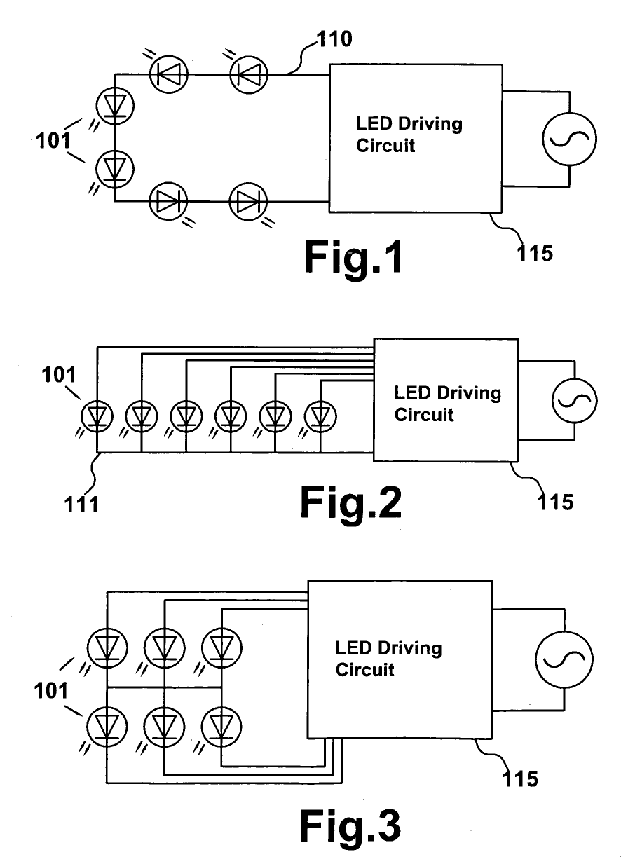

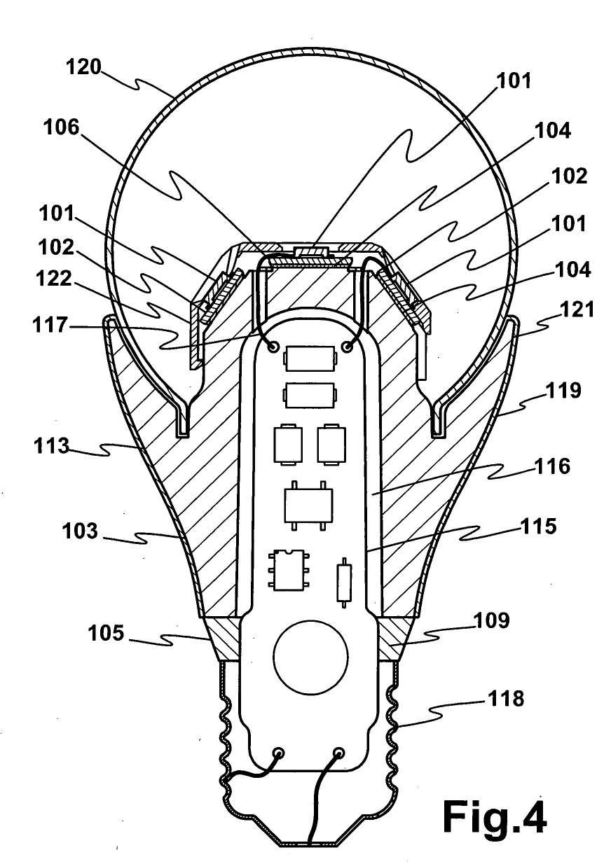

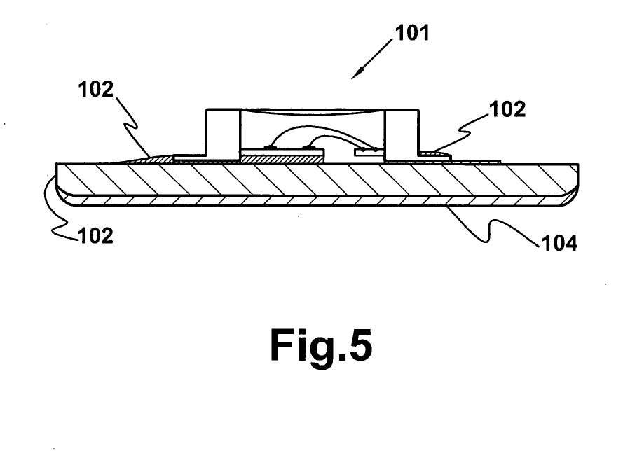

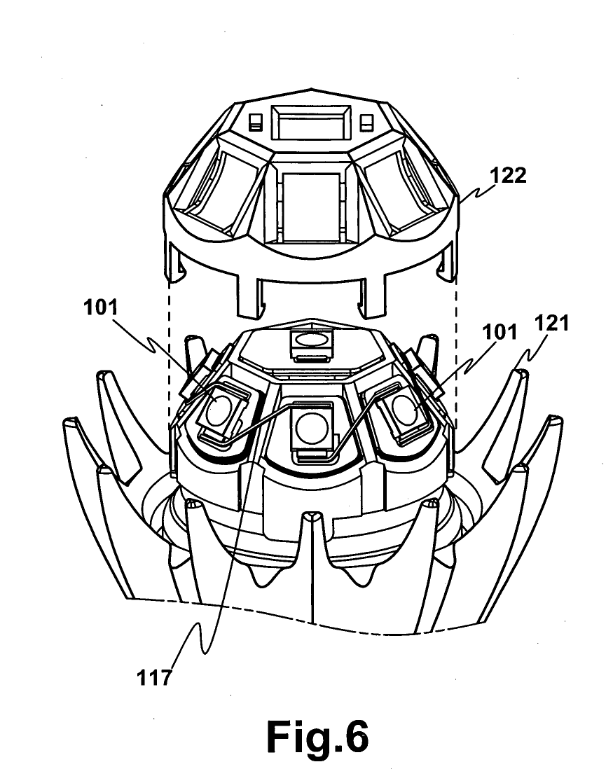

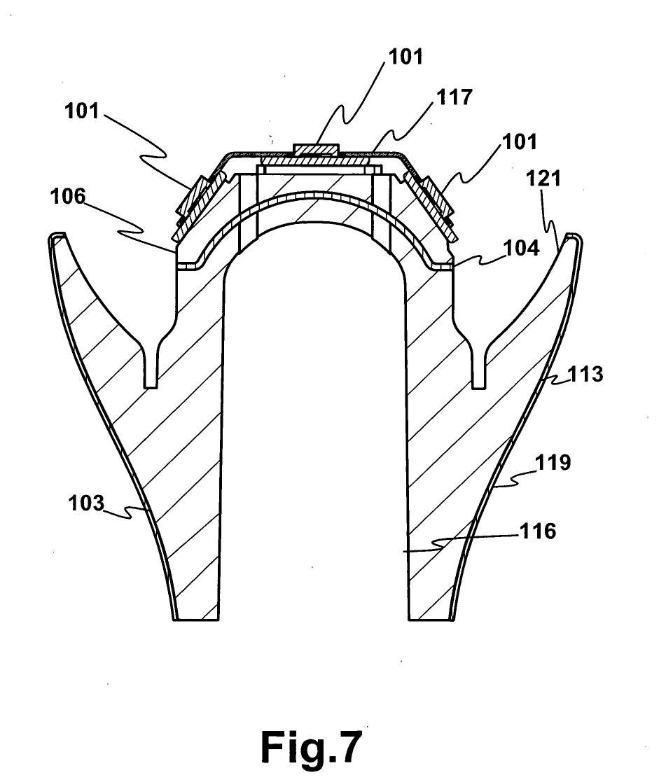

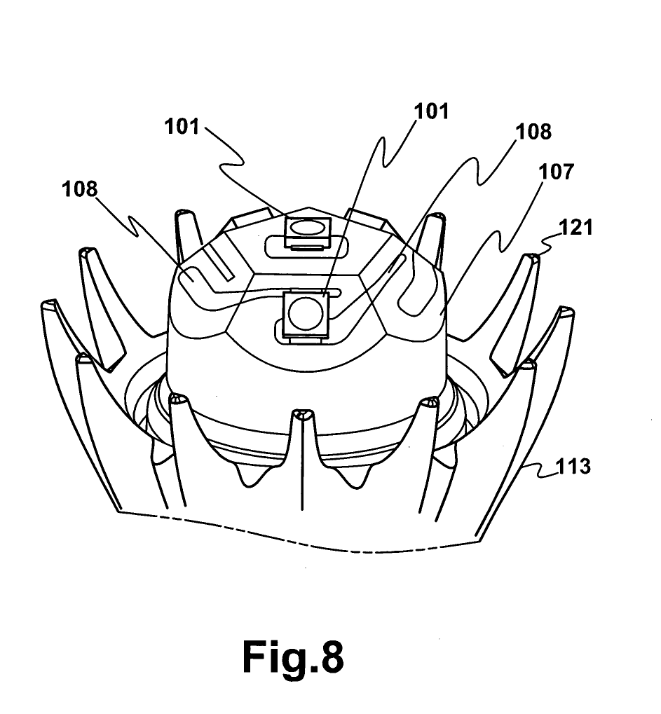

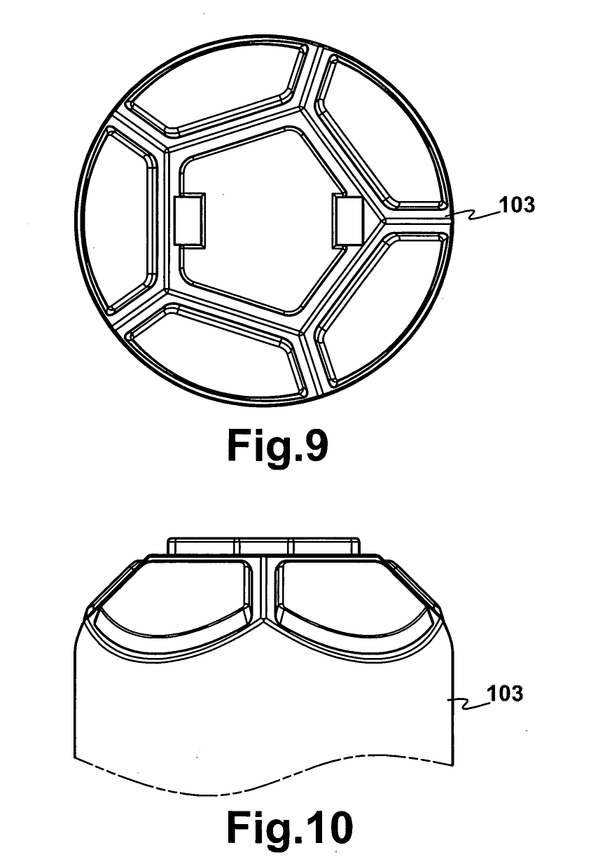

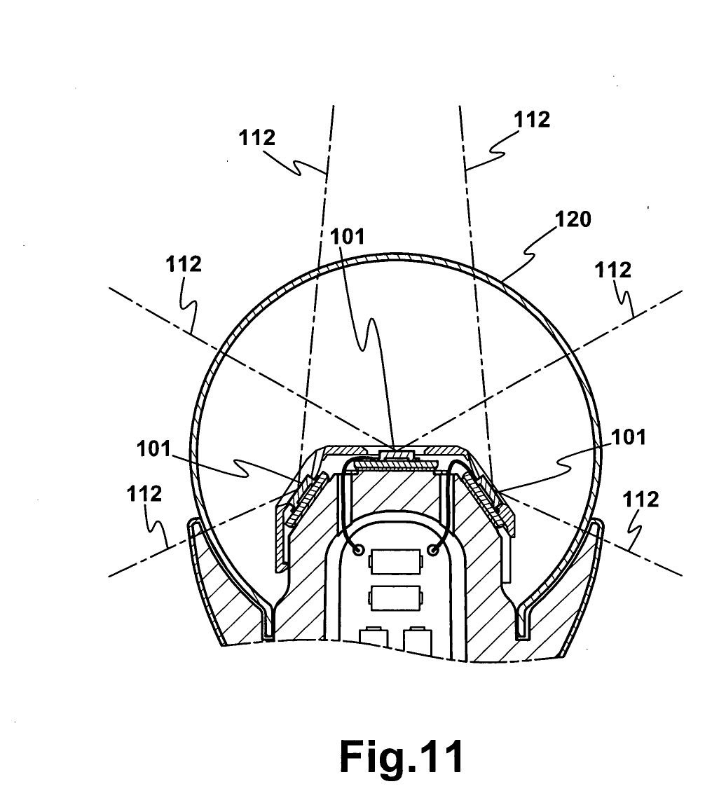

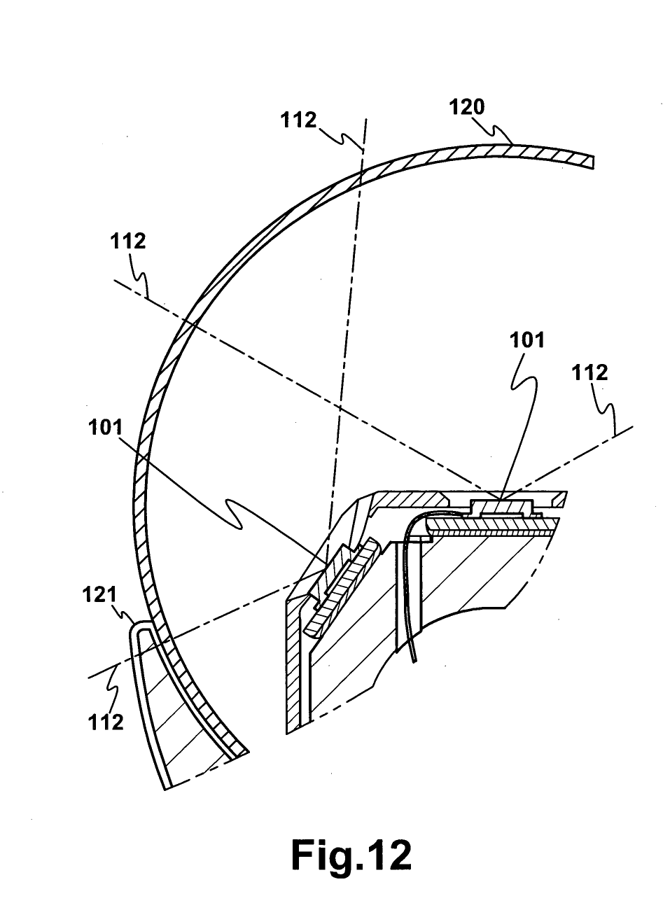

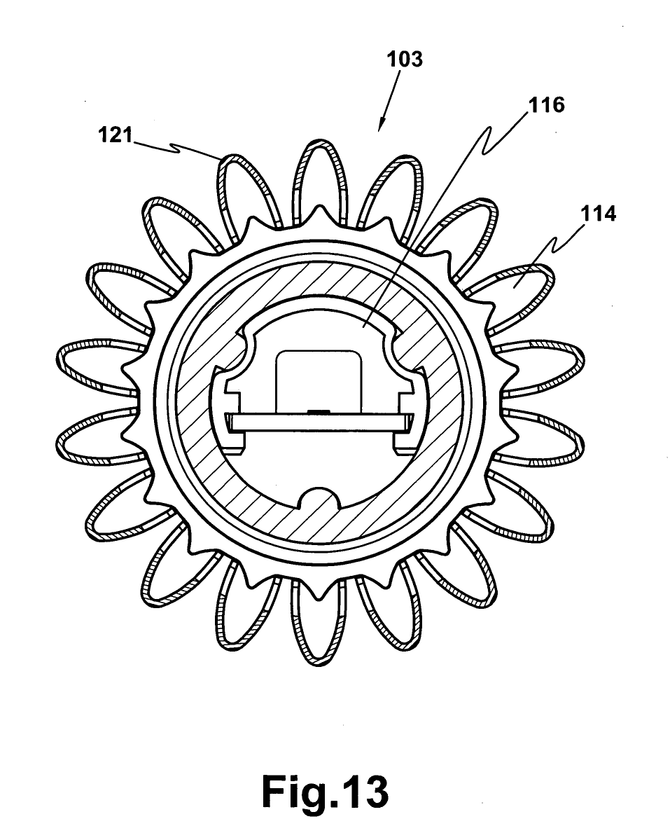

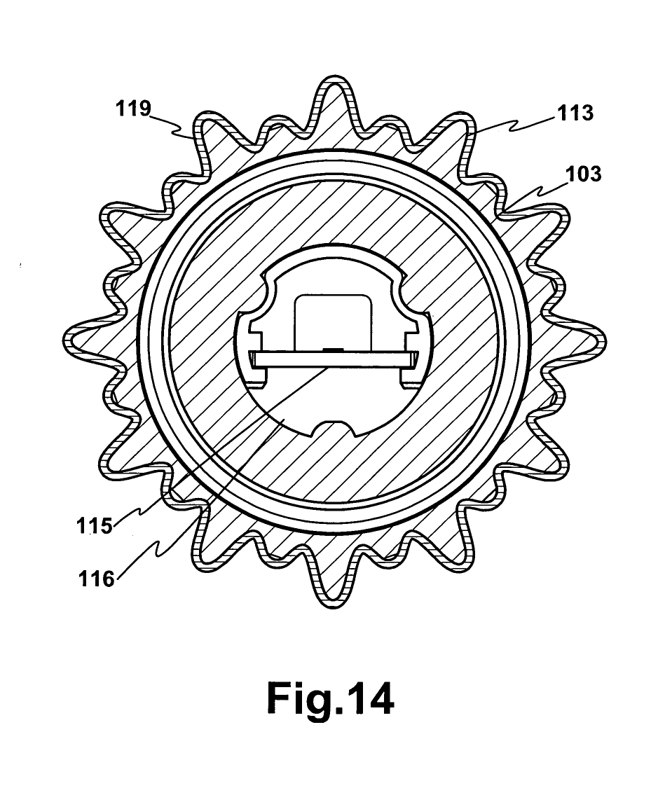

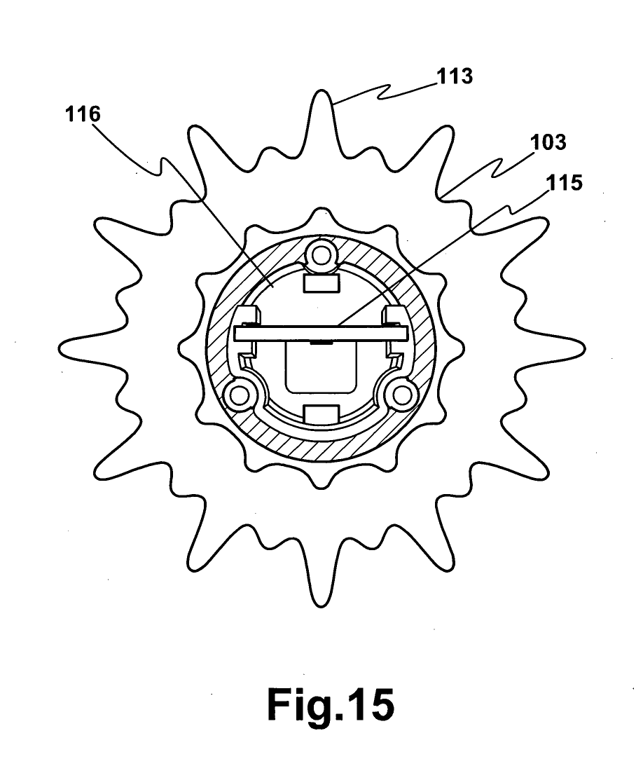

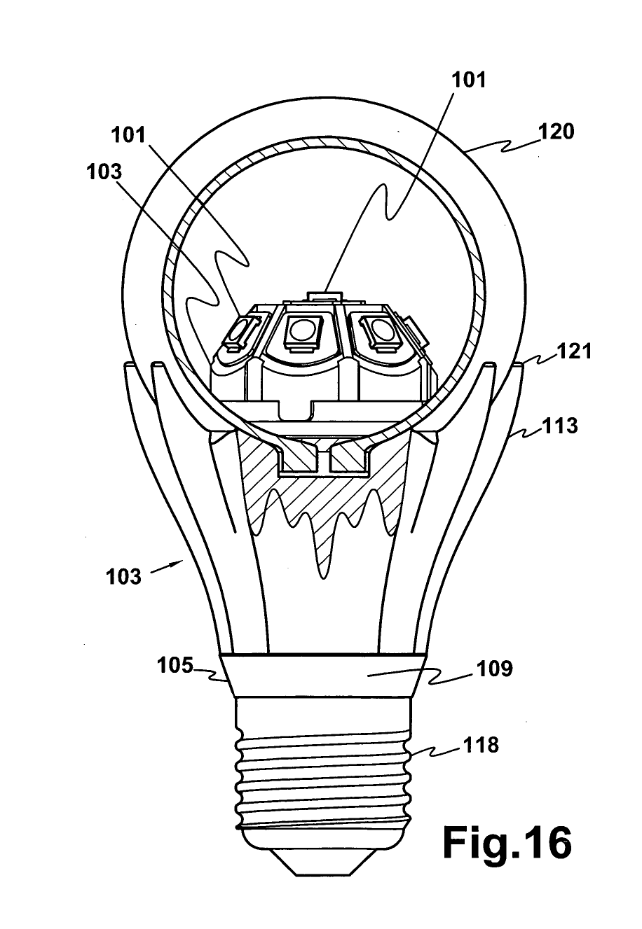

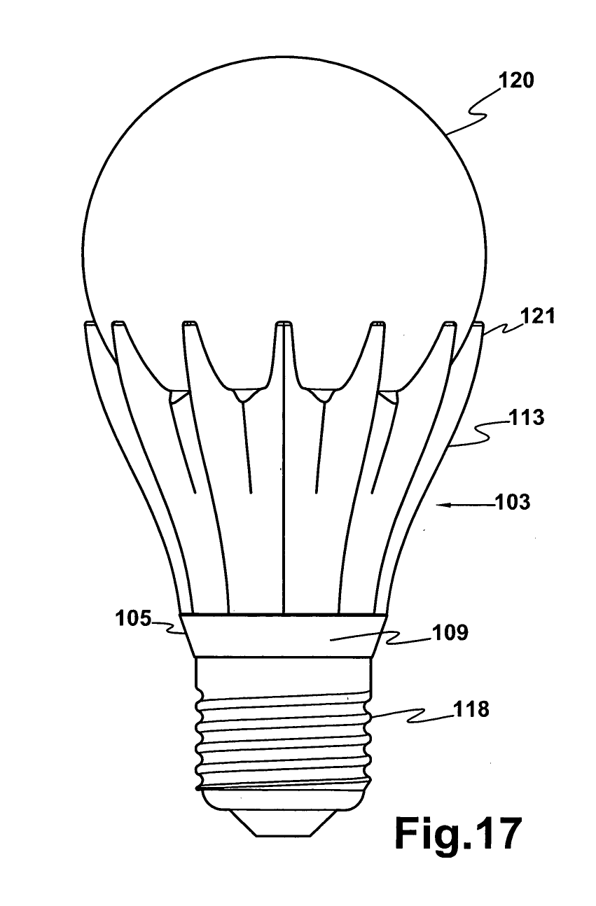

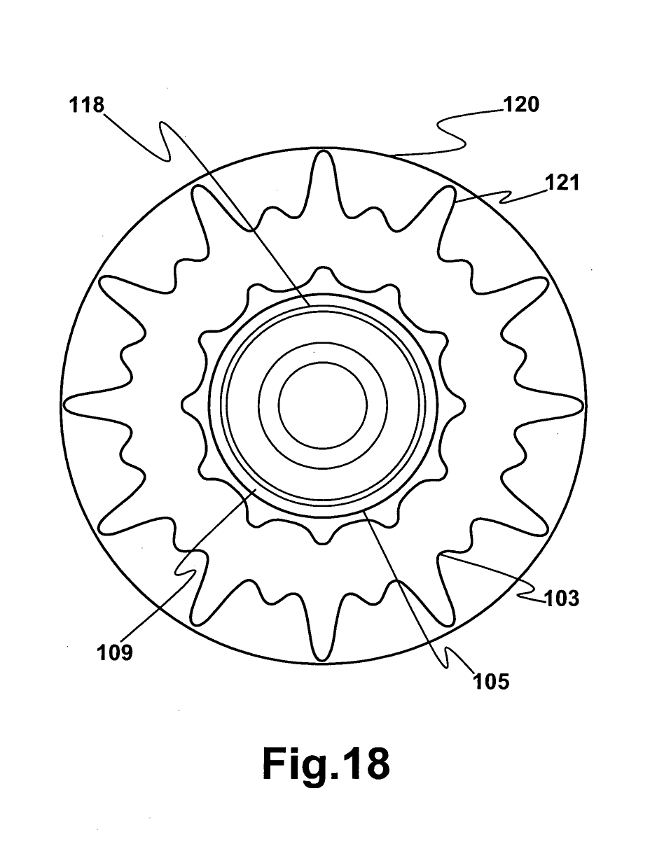

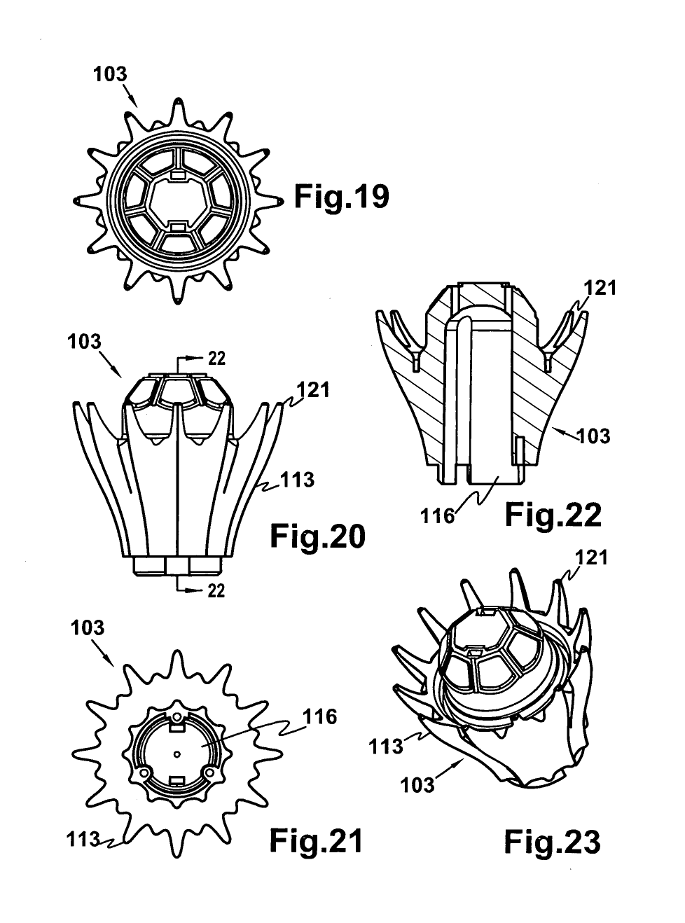

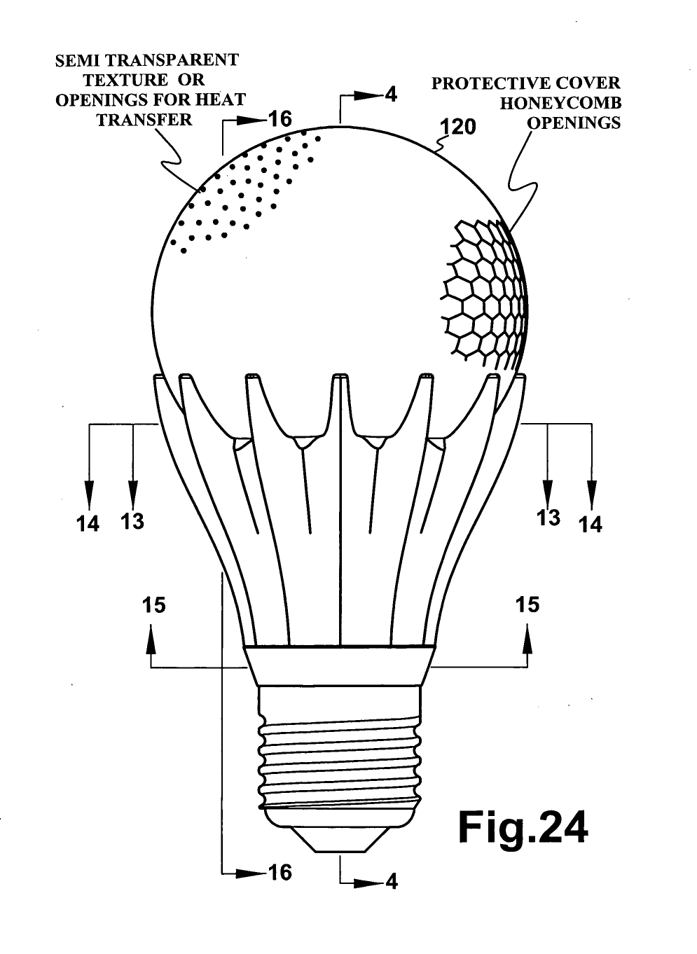

### NUMBERING OF ELEMENTS IN FIGURES

101 refers to LED units
102 refers to electrically conductive material
103 refers to a heat sinking structure.
104 refers to the layer of heat conductive material
105 refers to fixing structure
106 refers to a structure conductive part such as metal for mounting and or as part of an electronic circuit
107 refers to a ceramic heat sink
108 refers to bonding layer structure or metallic soldering pads bonded on ceramic heat
109 refers to insulative layer or for LED anode
110 refers to LED anode connection element
111 refers to LED cathode electrical connection element
112 refers to field of illumination of an LED units
113 refers to heat sinking fin structural
114 refers to holes on the heat sink of heat sinking structure.
115 refers to LED driving circuit of in the embodiments.
116 refers to housing for the LED driving circuit for LED driving circuit in various embodiments.
117 refers to electrical conductor such as double insulation wire for connecting between LED driving circuit and LED units.
118 refers to an Edison's screw base or other type of base for electrical power source connection and or mounting of the device in a fixture
119 refers to a outer coating on a heat dissipation
120 refers to a semi-globular membrane
121 refers to a sawtooth segment of a heat sinking structure
122 refers to semi transparent texture or openings for heat transfer
123 refers to protective cover honeycomb openings

What is claimed is:

1. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
a radial fin structure of said heatsink extending around the exterior optical part of said protective membrane;
said radial fin structure having gaps between fins for illumination to operatively pass through said gaps between said fins.

2. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
a heat sink structure of said heatsink extending around the exterior of said protective membrane;
an insulator structure affixed operatively separating said heatsink and said Edison base electrical connection.

3. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central position in the interior area of said protective membrane to the exterior area of said protective membrane;
a heat sink structure of said heatsink having a radial fin structure with holes in said fin structure wherein said heatsink structure extends radially around the exterior direct illumination field of said protective membrane;
an insulator structure affixed between said heatsink and said Edison base.

4. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
the internal structure of said heatsink formed as a housing of metallic material containing an electrical driving circuit for said light emitting diodes;
said internal housing forming a metallic electromagnetic shield structure.

5. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
said heatsink having a layer of coating to provide safety protection to the user.

6. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
said heatsink having a layer of heat conductive electrically insulative material separating the portion of said heatsink upon which said light emitting diodes are mounted from the portion of the heatsink which extends to the exterior of said protective membrane.

7. A light emitting diode illumination device substantially filling the three-dimensional footprint shape of a traditional Edison base incandescent lightbulb wherein said illumination device comprises:
a semi-globular transparent outer protective membrane covering light emitting diode sources of illumination;
said protective membrane covering a portion of a faceted heatsink upon which said light emitting diodes are mounted upon facets;
said light emitting diodes thermally connected to said heatsink wherein the thermally conductive structure of said heatsink extends from a central optical position within the interior area of said protective membrane to the exterior area of said protective membrane;
structures of electrically insulative material operatively connected to said heatsink serving as a barrier to electronic circuitry for prevention of harmful electrostatic discharge.
